(19) United States
(12) Patent Application Publication
(10) Pub. No.: US 2013/0328348 A1
(43) Pub. Date: Dec. 12, 2013

(54) Integral solar panel system for an electric vehicle

(71) Applicant: Brooks Alexander Agnew, Concord, NC (US)

(72) Inventor: Brooks Alexander Agnew, Concord, NC (US)

(21) Appl. No.: 13/682,682

(22) Filed: Nov. 20, 2012

Related U.S. Application Data
(60) Provisional application No. 61/656,556, filed on Jun. 7, 2012.

(51) Int. Cl. B60K 16/00; H02J 7/00; B60P 7/02

(52) U.S. Cl. CPC B60K 16/00; B60P 7/02; H02J 7/00
USPC 296/136.03; 248/205.1; 320/101

(57) ABSTRACT

Integral solar panel for an electric vehicle to recharge the traction battery pack. An integrally installed electronic solar panel array that is capable of fully recharging an automobile with energy obtained from sunlight or other wavelengths of ambient energy. Such an energy collecting panel is modular and may be removed or replaced with common tools. Further, such a collecting panel is non-glass, shatterproof, and non-glare. Further still, such a solar panel is designed to provide an isolated source of power to directly recharge the main traction storage device, such as a battery or a capacitor.

### CROSS REFERENCE TO RELATED APPLICATIONS

The present application claims priority of U.S. provisional application No. 61/656,556, filed on Dec. 1, 2011, which is herein incorporated by reference.

### BACKGROUND TO THE INVENTION

This invention relates to the technical field of automobile manufacture. More particularly, the present invention relates to the manufacturing of an electric vehicle with an integral solar battery charger.

### FIELD OF THE INVENTION

### Description of Related Art

The current state of the art is to recharge the traction storage device from an external power source, located in a specific space, which is connected to the vehicle via an electrical cord or through other means such as inductive coupling. The current state of the art for recharging the traction storage device for electric vehicles utilizes an energy source for recharging that is located in a fixed position, such as an electrical power receptacle for the vehicle's onboard charger, an external charger connected to an energy source such as a solar array, a wind generator, or an electrical power distribution grid.

### Brief Summary of the Invention

The present invention is in the technical field of electric vehicle energy storage device recharging technology. More particularly, the present invention is in the technical field of collecting and converting energy from the sun, and/or other ambient sources, for the purpose of recharging the traction storage device. Those familiar with the art will recognize the advantage in driving range improvement, remote recharging capabilities, and battery life extension provided by the present invention.

Those familiar with the art will recognize the unique and novel improvement of the current invention for collecting, converting, and supplying traction storage device recharging energy from sunlight, and other wavelengths of ambient energy. Further, this invention serves as an integral function during the entire life of the vehicle, whether or not the vehicle is connected to an external source of energy, through a power cord, or an inductive coupling device. The chemical reaction involving the free exchange of ions is particularly susceptible to short-term and long-term damage due to lack of available free ions during various states of discharge. More particularly, the chemistry may form insoluble or irreversible products during this state of discharge due to the unavailability of free ions. The integration of this invention supplies a continuous, positive quantity of free ions to the overall traction storage device, such as a rechargeable Lithium chemistry battery, which experimental data has shown to have a preventive effect on the formation of insoluble and irreversible products during states of discharge for that device. Those familiar with the art will recognize that the ongoing formation of these insoluble products diminishes the power storage capacity of the device due to an apparent reduction in the chemistry to provide enough available ion states. The unique and novel aspect of the current invention provides a continuous positive flow of ions to the chemistry during the hours from sunrise to a few hours after sunset that the current state of the art does not receive, thus adding value to the proposition of electric vehicle ownership by preserving the relatively large investment in the traction storage device for a longer period of time than the current state of the art.

The present invention is in the technical field of electric vehicle energy storage device recharging technology. More particularly, the present invention is in the technical field of collecting and converting energy from the sun, and/or other ambient frequency sources, for the purpose of recharging the traction storage device. Those familiar with the art will recognize the advantage in driving range improvement, remote recharging capabilities, and battery life extension provided by the present invention. Those familiar with the art will recognize the unique and novel improvement of the current invention for collecting, converting, and supplying traction storage device recharging energy from sunlight, and other wavelengths of ambient energy, as an integral function the entire life of a commercially available highway-ready vehicle, whether or not the electric vehicle is recharged via an external source of energy through a power cord or inductive coupling device.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a depiction of the solar panel in a thin-profile design with a shatterproof lamination subassembly.

FIG. 2 is a depiction of the molded rubber extrusion profile that contains the solar panel, prevents the edges of the solar panel from being exposed to moisture, and mounts the solar panel to the slightly curved rooftop of a compact pickup truck.

FIG. 3 depicts an integral solar panel mounted to the roof section of the electric truck cab.

FIG. 4 is a depiction of a tonneau cover to the compact pickup truck bed that is fitted with solar panels

FIG. 5 is a depiction of a box van truck bed fitted with solar panels.

FIG. 6 depicts a Battery management System (BMS) device that converts the voltage of the solar panel output to the voltage of the traction storage device as a direct input through an isolation relay and control circuitry common to the electric vehicle industry.

### DETAILED DESCRIPTION OF THE INVENTION

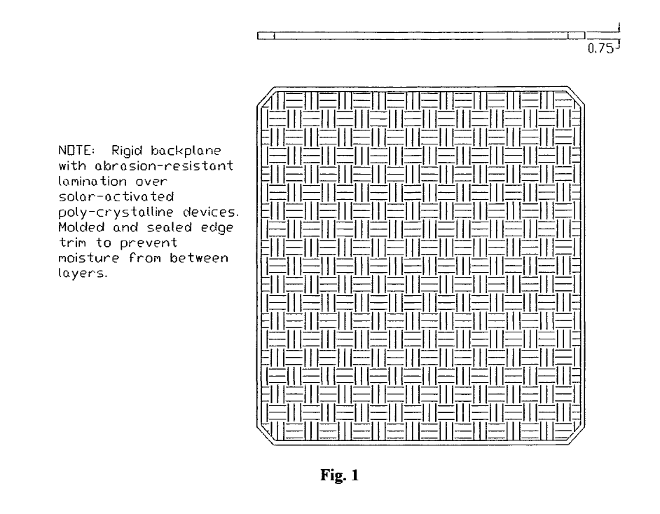

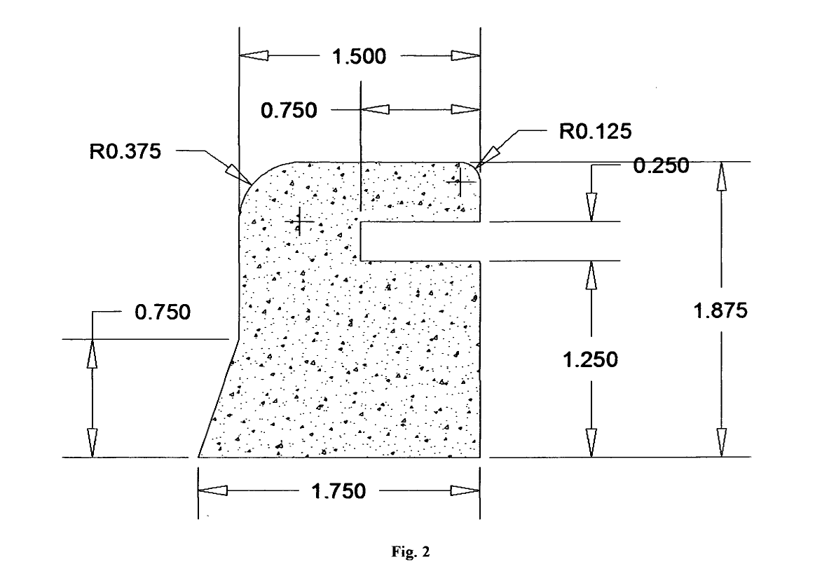

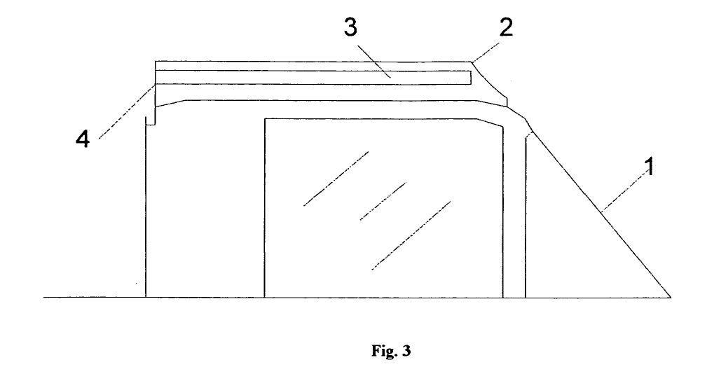

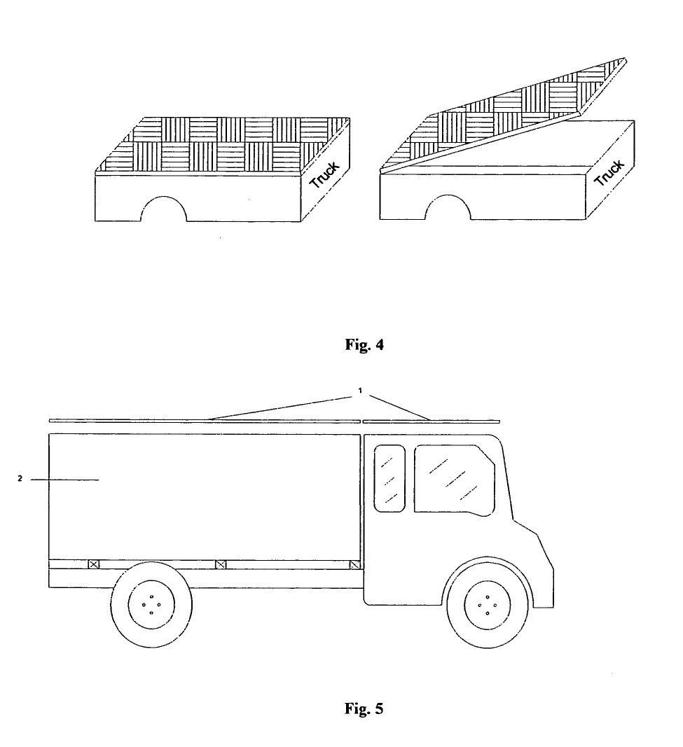

Referring now to the invention in more detail, FIG. 1 shows a solar panel is mounted via a flexible extruded rubber molding, shown in FIG. 2, to the roof of an electric compact pickup truck (FIG. 3). This is aerodynamic to prevent drag on the vehicle while it is moving. The attachment is through an adhesive between the molding (FIG. 2) and the roof area (FIG. 3), or to a tonneau cover (FIG. 4), or to the box van (FIG. 5). Now referring to the drawing in FIG. 1, a poly-crystalline solar panel may be utilized as a power source to recharge the main traction storage device. There are various sources of clean and renewable energies that are suitable for recharging the traction storage device, such as a battery system. The current state of the art of this type of recharging is to collect energy from the sun in a stationary collection station, and then to distribute this stored energy as a charging station to the electric vehicle via a power cord or inductive connection process. Those familiar with the art will recognize that the ability to carry the solar charging ability as an integral part of the vehicle is an improvement over the current state of the art.

Still further, the current invention mounts the solar panel onto the roof of the vehicle in an aerodynamic manner, using a smooth, flexible extruded profile shown in FIG. 2. The Windshield line in FIG. 4 (1) is utilized in a manner to guide the wind up and over the solar panel to minimize the wind resistance. The extruded molding in FIG. 2 forms a secure shelf for the solar panel to be mounted into a slot in the molding capable of fitting the solar panel.

Still further, the top of a cargo box as shown in FIG. 5, or the pickup truck tonneau cover as shown in FIG. 4, are fitted with solar panels so as to provide a net positive energy supply without detracting from the forward motion of the vehicle throw wind resistance or excessive weight.

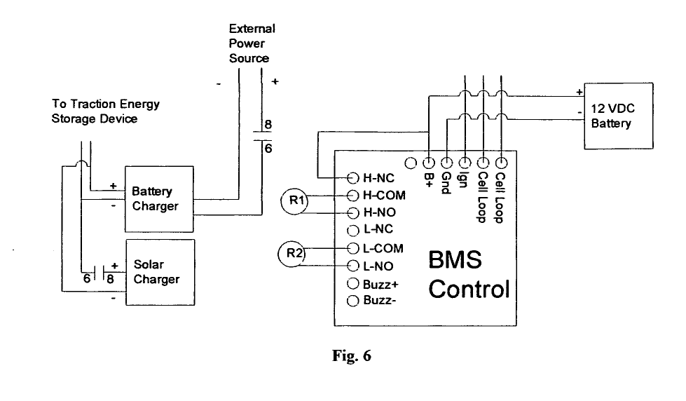

Still further, the current invention may utilize other ambient energies beside those energies commonly available from the sun in an integral device, as shown in FIG. 3. Still further, the application of integral devices to collect and convert the energy through a circuitry, as depicted in FIG. 6, so as to isolate the sensitive collection device from the high wattage of the traction storage device, such as a battery system, is unique and novel. R1 is the control relay that disconnects or energizes the main onboard battery charger. R2 is the isolation relay that disconnects the solar panel from the traction storage device.

A feature of the present invention is that the solar panels are not covered with glass, so they are very lightweight, thus producing more energy for the traction storage device that that energy required to transport the weight of the solar device itself.

Another feature of the current invention is the light weight and the high efficiency, greater than 12%, of the solar collection device. The ability to supply energy to the traction storage device, such as a Lithium chemistry battery, the entire time the sun is shining is a notable advantage over the current state of the art, which is an electric vehicle that can only recharge when it is connected to the electrical power grid or another stationary source of energy. Another feature of the current invention is to extend the useful life of a traction storage device, such as a Lithium battery, by supplying an integral and continuous flow of ions to the chemical reaction so that insoluble and irreversible products detrimental to the life of the battery are not formed. Only a small net positive flow of electrical energy is required to provide this chemical benefit. The current invention may provide enough energy to accomplish this benefit, which is a marked improvement over the current art.

Another feature of the current invention is to extend the range that a high-speed electric vehicle can travel between charging sessions at a plugin station. More particularly, those familiar with the art will recognize that golf carts, or other low-speed vehicles usually operate on relatively low voltage, such as 12, 24, 36, 48, or 72 volts using low-cost batteries such as AGM lead acid batteries. These voltages may be available directly from a solar panel, but it requires an efficient conversion between the output voltage of the solar panel and the charging voltage accepted by the batteries. Those familiar with this art will recognize that an efficient and isolated conversion for a traction storage device, such as Lithium chemistry batteries, parallel to the onboard or outboard powered charging system so as to supplement the range performance of a highway-speed electric vehicle.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. Moreover, the terms “consisting”, “comprising” and other derivatives from the term “comprise” are intended to be open-ended terms that specify the presence of any stated features, elements, steps, or components, and are not intended to preclude the presence or addition of one or more other features, elements, integers, steps, components, or groups thereof. Moreover, Applicants have endeavored in the present specification and drawings to draw attention to certain features of the invention, it should be understood that the Applicant claims protection in respect to any patentable feature or combination of features referred to in the specification or drawings. The drawings are provided to illustrate features of the invention, but the claimed invention is expressly not limited to the illustrated embodiments.

We claim:

1. An integral solar charging system for the main traction storage device for an electric vehicle.

2. The integral solar charging system of claim 1, wherein the electric vehicle is capable of highway speeds.

3. The integral solar charging system of claim 1, comprising one or a plurality of solar panels.

4. The integral solar charging system of claim 1,
wherein said system produces a net gain of energy to the traction storage device as compared to the additional weight and wind resistance it may add to the operation of that vehicle at all posted speed limits for a motor vehicle.

5. The integral solar charging system of claim 1, comprising an automatic isolation for the traction storage device of an electric vehicle such that the storage device will be connected to the solar recharging unit at all times, except when the storage device has been determined to have reached a full state of charge by an integral battery management system.

6. A method of powering a highway speed electric vehicle, comprising the direct conversion of solar energy through the system of claim 1, or other ambient frequencies of energies, into electricity of suitable form to recharge the integral traction storage device in such a highway-speed electric vehicle.

7. A molded, modular surface mount for a solar panel, said surface mount sized to fit the roof of an electric vehicle in an aerodynamic manner to reduce its resistance to the wind while the vehicle is being operated, so as to securely contain a solar panel from moisture and erosion from underneath the panel.

8. A molded tonneau cover for a pickup truck that is integrally constructed with the solar charging system of claim 1, so as to form a solar electric vehicle traction battery charger.
